(19) United States
(12) Patent Application Publication
(10) Pub. No.: US 2026/0103255 A1
(43) Pub. Date: Apr. 16, 2026

(54) Height-Adjustable Seatpost with Suspension Function

(71) Applicant: Marzell MAIER, Insy (DE)

(72) Inventor: Marzell MAIER, Insy (DE)

(21) Appl. No.: 19/357,887

(22) Filed: Oct. 14, 2025

(30) Foreign Application Priority Data
Oct. 16, 2024 (DE) DE102024130092.2

(51) Int. Cl. B62J 1/08; B62J 1/06

(52) U.S. Cl. CPC B62J 1/08; B62J 1/06; B62J 2001/085

(57) ABSTRACT

Proposed is a height-adjustable seatpost (1) with combined saddle suspension, in particular for gravel bikes, comprising an upper tube (2), wherein a saddle is fastenable to the upper end (4), and a lower tube (3), in which the lower end of the upper tube (2) is mounted telescopically in a plunging configuration, wherein a gas spring (5) is provided which couples the upper tube (2) to the lower tube (3) such that the upper tube (2) can be mounted elastically relative to the lower tube (3), wherein the gas spring (5) has a piston (6) having a push rod (8) and has a pressure housing (7) which forms a chamber (12) in which the piston (6) is mounted, wherein the push rod (8) is connected to the upper tube (2) and the pressure housing (7) is connected to the lower tube (3). In the seatpost (1), which requires little maintenance effort, the pressure housing (7) forms a cylinder which is separate from the lower tube (3) and which is mounted coaxially in the lower tube (3) and fixedly connected to the lower tube (3).

### CROSS-REFERENCE TO RELATED APPLICATION

This Application claims priority to German Application No. 102024130092.2, filed Oct. 16, 2024, the contents of which are hereby incorporated by reference in their entirety

### BRIEF DESCRIPTION OF THE DRAWINGS

FIG. 1 shows a schematic section through a seatpost, according to one example.

FIG. 2 shows a schematic section through the gas spring from the seatpost of FIG. 1.

FIG. 3 shows a schematic section transversely through the arrangement of upper tube and lower tube, in one example.

### DETAILED DESCRIPTION

The present disclosure relates to a height-adjustable seatpost with combined saddle suspension for a bicycle, which seatpost may be suitable in particular for use on a gravel bike. The present disclosure also relates to a corresponding frame, and to bicycle or gravel bike.

Height-adjustable seatposts for bicycles are known from the prior art. For the height adjustment, an upper tube or stanchion and a lower tube are arranged telescopically one inside the other, that is to say, to adjust the saddle height, the upper tube is let further into the lower tube such that the saddle is lowered, or conversely the upper tube is pulled further out of the lower tube to make the saddle higher. The height adjustment may be implemented by means of a hydraulic cylinder. In addition to the purely hydraulic embodiment, suspension may also be implemented by means of a separate air chamber or spiral spring. Lowerable seatposts having hydraulic-pneumatic devices are known for example from DE 20 2023 104 757 U1 or DE 10 2022 125 953 A1. In this case, a gas spring is inserted into the upper tube of the seatpost on which the saddle is mounted. According to further prior art that is described for example in DE 10 2023 132 300 A1, the lower tube is formed as a pressure housing of an air chamber. An adjustable construction of a seatpost tube having a gas spring is also known from DE 20 2011 003 032 U1.

By contrast, it is an object of the present disclosure to propose a height-adjustable seatpost which additionally offers a suspension function requiring the least possible maintenance effort and which is therefore usable in particular for gravel bikes.

Proceeding from a seatpost of the type mentioned in the introduction, the object is achieved by means of one or more features of the present disclosure.

Advantageous embodiments and refinements of the present disclosure are possible by means of the measures specified in the subclaims.

In particular, two interrelated functions are implemented in the seatpost according to one example, namely the height adjustment of the saddle and the suspension thereof. For this purpose, the seatpost firstly comprises an upper tube and a lower tube which are arranged telescopically relative to one another, that is to say the upper tube has a smaller diameter than the lower tube and can be sunk or retracted into said lower tube.

The lower tube may constitute a part of the frame, may be welded to the rest of the frame, or may be coupled thereto.

According to one example, the lower tube and upper tube are mechanically coupled by means of a gas spring. The gas spring consists generally of a pressure housing in which a piston is mounted. The piston is mounted in a chamber which is filled with a gas (for example air), which in particular is pressurized. The piston may divide the chamber into a positive and a negative chamber, wherein it is initially also the case that no gas can flow across from the positive to the negative chamber and vice versa. The piston is connected to a push rod, which in turn is connected to the upper tube. The saddle can be fastened to the upper tube. The pressure housing is fixedly connected to the lower tube. Since the gas is compressible, the upper tube can be moved somewhat relative to the lower tube, that is to say, under loading, the gas is compressed, and as soon as the impulse on the upper tube diminishes, said gas expands again and pushes the upper tube into the initial position.

A damping action of the gas spring generally results from the friction of the mounting of the piston in the pressure housing or of the seals of the gas spring.

Such a suspension is advantageous for example if a corresponding bicycle is used off-road, or is subjected to shocks in some other way. A typical application is for gravel bikes. Some bicycles have no suspension at the rear wheel. In order that said shocks however cannot be transmitted to the rider, the seatpost can be equipped with a suspension. For example, parallelogram guides are conceivable for this purpose in order to implement a spring travel. However, such parallelogram guides take up more structural space.

The seatpost according to one example thus also has a design which is much less complex in terms of construction and in terms of manufacturing than a seatpost having hydraulic height adjustment and having an additional spiral or air chamber.

With one example, it is accordingly ultimately possible to achieve numerous advantages:
Firstly, a height-adjustable seatpost with suspension function is proposed.
This can be constructed so as to have a low weight.
It may be distinguished by easy serviceability.
It is also mechanically particularly robust.
With these advantages, it is ideally usable for gravel bikes.

The guide of the saddle is advantageously equipped with a rotation-preventing means in order to prevent undesired rotation of the saddle. The height adjustment of the saddle, and the suspension, are associated with the provision of a vertical degree of freedom. Provision is therefore made according to one example for the height adjustment and suspension function to be combined with one another.

According to one example, the gas spring is designed so as to comprise a dedicated pressure housing which is fastened in the lower tube. This overcomes the technical preconception that the lower tube itself must serve as a pressure housing in order to save weight and space. This is because such a conventional lower tube from the prior art exhibits major disadvantages with regard to its manufacture: Guide grooves for the rotation-preventing means must be formed in the upper part of the lower tube, which guide grooves are formed over the entire length of the tube only by means of a reaming process. Said guide grooves therefore conventionally cannot be formed with an arbitrary depth; this is because, in that region of the lower tube which in said prior art serves as the pressure housing of the gas spring, and in which the piston is intended to move, the piston must be able to lie tightly against the housing inner wall. That is to say, in an additional working step, the inner surface must be made cylindrical again, for example by a material-removing turning process, in order to enable the gas spring piston to seal against the lower tube. The diameter of the cylinder must be greater than the envelope diameter of the interior space with guide grooves. This machining step fundamentally reduces the stability of the lower tube, because the wall thickness is reduced during the material-removing turning process in said region. In the prior art, in order to counteract this, the wall of the lower tube is reinforced, that is to say made thicker. This in turn give rise to a higher weight and a greater space requirement. Since this however means that the depth of the guide grooves is also only limited, both guide grooves and guide pins can quickly become worn.

Therefore, the seatpost according to one example offers a guide which exhibits less wear and has a smaller space requirement. Since the seatpost according to one example has a dual function, namely the height adjustment and the suspension, integrated therein, movement of the upper tube and lower tube relative to one another is to be expected constantly during use, which places a high load on the guide. One example thus offers the possibility of providing a guide or rotation-preventing means which can better withstand the high mechanical demands or loads and which is more stable and reliable.

The serial configuration of the gas spring with respect to the telescope of the seatpost generally causes a seatpost to be longer than is possible in the case of integration into the upper tube. Since the requirement for maximum adjustment travel is generally not of primary importance for a post for gravel bikes, the serial arrangement is sensible because the overall length of the post must be realized despite a smaller stroke.

The situation is different in the case of conventional mountain bikes: In the case of adjustable seatposts on a mountain bike, the focus is on a maximum adjustment travel. In the case of a mountain bike, adjustment travels of typically up to 240 mm are available, depending on the size of the person.

By contrast, in the case of a gravel bike, adjustment travels of between 60 mm-100 mm are advantageous in order to greatly improve downhill handling. The off-road capabilities of a gravel bike are generally lower than those of a mountain bike. Accordingly, the adjustment possibilities required by the user of a gravel bike are also less.

However, if the pressure housing of the gas spring is integrated in the upper tube, as is also already conventionally implemented in the prior art, the diameter is reduced in relation to an arrangement in the lower tube. The smaller piston area however also means that it is necessary to operate with much higher pressures in the gas spring. The push rod is led through on the side of the negative chamber. The effective piston area is furthermore also reduced by the cross-sectional area of the push rod, such that relatively high pressures prevail there in particular.

In the case of mountain bikes, actuation by means of a remote control on the handlebar has become established, which provides particularly high user convenience. Here, the articulation on the post is implemented from the underside.

However, in the case of gravel bikes with curved handlebars, there is the fundamental problem that the operator control on the handlebar cannot be implemented as easily owing to the different grip positions.

Furthermore, in order to uninstall the seatpost, it is necessary to remove the handlebar tape, which additionally makes servicing more complex.

According to the concept of one example, however, use is made of the fact that the lowering function is normally used less in the case of a gravel bike than in the case of a mountain bike; this therefore allows the straightforward solution involving actuation under the saddle. Both versions, on the one hand with remote control or on the other hand with actuation under the saddle, are implemented from above and therefore do not restrict serviceability. According to one example, it is also possible for both versions to be implemented.

An implementation with a gas spring in the upper tube and actuation from above requires an additional coaxial piston rod, which would further reduce the size of the positive chamber area and necessitate an extremely high chamber pressure.

According to one example, it is advantageously possible to avoid such high pressures. In the case of the gas spring, it is also possible according to one example to pump air into the pressure chamber using a commercially available bicycle pump, which greatly simplifies use, even when on the go. This is because, in the case of gravel bikes, seatpost diameters are normally 27.2 mm. That is to say, if one were to integrate a gas spring into such an upper tube or stanchion, the diameter of the gas spring would also have to be correspondingly small, and it would therefore be necessary to operate with high pressures.

Furthermore, one example offers the advantage that an adjustment can be performed from the upper tube or from the side of the saddle, which is much more convenient than if such an adjustment had to be performed from below on the lower tube. Depending on the space requirement, an adjustment may be performed electrically or mechanically.

In one embodiment, the chamber of the pressure housing is divided into a positive and a negative chamber, wherein the piston separates the positive chamber from the negative chamber. If the height of the saddle is fixedly set, and if slight changes in the position of the saddle occur only during spring deflections owing to shocks (for example in off-road situations), then the gas quantities in the positive chamber and in the negative chamber are maintained. Only owing to the compression action, for example in the event of a shock, does the piston compress the gas in the positive chamber such that the volume there is briefly reduced, that is to say the gas situated therein is compressed. Conversely, the gas in the negative chamber must then expand.

In one design variant, the negative chamber is arranged at the side facing the upper tube or stanchion.

The profile of the spring characteristic curve can be adjusted by means of the volume ratios of the two chambers (positive and negative chamber). If the volume of the negative chamber approaches zero, then the suspension of the seatpost is also very hard or rigid. If the post or the upper tube is partially lowered, the ratio of the chamber volumes, and thus the spring characteristic curve, change. The spring characteristic curve becomes flatter because the negative chamber becomes larger. This however scarcely plays a role in practice because, in general, during use, the post is fully extended (if the bicycle rider is in a seated position when pedaling) or is fully lowered (during downhill riding, the bicycle rider typically stands on the pedals, such that no loading is exerted on the saddle). According to one example, height adjustability and suspension are combined, which also has the effect that, during the adjustment of the height by means of the gas spring, the volume ratios and gas quantity ratios of the positive and the negative chamber relative to one another change.

To realize this, in one refinement, a first valve is integrated into the piston and makes a pneumatic connection possible between the positive and the negative chamber. The sum of the gas quantities in the positive and the negative chamber remains constant when the first valve is actuated, because overall no gas escapes from the chamber or flows into the chamber when said valve is actuated. The position of the piston in the rest state, that is to say the height of the piston in the pressure housing, however changes when the first valve is actuated, and the saddle height thus also changes. If the first valve is opened, the seatpost or the upper tube is pushed upward by the effective force of the gas spring. Said force arises owing to the difference in area between the piston bottom side and the piston top side, and the positive pressure prevailing in the pressure housing relative to atmospheric pressure. This function can be optimally utilized for automatic raising of the post upon an actuation. For lowering, it is relatively easily possible, using the buttocks, to move the post into the desired position counter to the force generated when the first valve is opened.

In practice, however, seatposts are normally used in the fully retracted or extended state, such that a change to the spring characteristic curve in the intermediate saddle height positions often have no particular relevance in practice.

The first valve may be designed as a piston valve. It is advantageously thus possible in principle for any desired states of opening of the valve between the fully open state and the fully closed state to be set, whereby convenient and precise height adjustment of the saddle can be achieved.

In one design variant, the height adjustment may be implemented by means of a valve push rod, which at one end is connected to the valve and at the other end is actuatable mechanically, for example by means of a lever, or electrically.

The valve piston may be preloaded by means of a spring in order that the first valve is opened only when the saddle height is actually to be adjusted, and the valve otherwise remains in the closed position in order that suspension of the saddle is provided. The preload by means of the spring may however also be omitted. The valve is (in the absence of other external acting forces and in the absence of actuation of the lever) pushed into a “closed” position, because the push rod of the valve is sealed off with respect to atmospheric pressure. That is to say, the closing force of the valve is calculated primarily from the pressure difference between atmospheric pressure and chamber pressure and the area of the valve push rod (small diameter with the two O-rings in a serial configuration). If load is exerted on the post, an additional force arises owing to the pressure difference generated between the positive and the negative chamber. This force is however relatively much lower. That is to say, the closing force of the valve is calculated primarily from the pressure difference between atmospheric pressure and chamber pressure and the area of the valve push rod (small diameter with the two O-rings in a serial configuration).

As already described, the saddle must be mounted by means of the seatpost so as to be prevented from rotating. For this purpose, it is for example possible for a groove to be formed in the lower tube, into which groove a bulge of the upper tube engages, wherein said bulge is correspondingly directed outward. The groove and the bulge advantageously extend along the longitudinal axis of the seatpost, such that the rotation-preventing action is provided over the entire extension length of the telescopic arrangement.

The hardness of the suspension can also be adjusted. In principle, the spring characteristic curve is also dependent on the position of the piston, more specifically on the volume ratio of the positive chamber to that of the negative chamber. By means of the second valve, it is also possible for air to be pumped into the chamber, that is to say into the system composed of the positive and the negative chamber, from the outside. The second valve may initially open to the positive chamber, that is to say the pressure in the positive chamber may be increased or lowered by means of the second valve. It is thus firstly possible in principle for gas to be replenished in order to nevertheless counteract a loss of gas from the chamber even though, in practice, this normally becomes noticeable only after very long periods of time. At the same time, the suspension can be adjusted by virtue of gas being supplied via the second valve. The seatpost according to one example is advantageously designed such that the pressure conditions in the gas spring allow gas to be supplied via the second valve by means of a simple air pump, such as is conventional in the bicycle sector.

The gas that is additionally introduced via the second valve enters the positive chamber and increases the pressure there. When the first valve is actuated, pressure equalization takes place between the positive chamber and the negative chamber.

The mounting between the upper tube and lower tube may be realized by means of a sliding bushing, such that the upper tube and lower tube slide on one another with little friction and also cannot tilt or become blocked.

The second valve may be designed as a Schrader valve, that is to say it can also, as a car valve, be used at any fueling station. Furthermore, a higher air pressure is possible than with a Dunlop or Blitz valve. Furthermore, owing to its non-return mechanism, it is generally more stable than the Blitz valve. Particularly high pressures can be achieved using a French or Sclaverand valve.

Accordingly, the aforementioned advantages of the proposed seatpost can be correspondingly achieved in a frame or a bicycle, in particular a gravel bike that is used off-road.

In one advantageous embodiment, the pressure housing or the gas spring lies against the inner shell of the lower tube. The surfaces may lie against one another over the full circumference around the longitudinal axis. The pressure housing can thus have the greatest possible diameter. By means of this measure, the piston can also cover as large an area or plunger area as possible, such that the pressure exerted by said piston is lower than in the case of a smaller plunger area, because the force can be correspondingly distributed over a larger plunger area. The suspension of the saddle can thus be improved. This can also have an advantageous effect on the need for maintenance.

Since the tube of the seatpost is generally of cylindrical form or formed with a round cross section, the gas spring may also correspondingly be formed with a round cross section or be of cylindrical form in order that it can be fitted in.

In one exemplary embodiment, the gas spring may form a mechanical stop for the upper tube, wherein, in particular in the case of gravel bikes, the adjustment travel is in any case generally not selected to be arbitrarily long; rather, it is more important that the force originating from the piston is distributed over a larger area that and the acting pressure can thus be reduced.

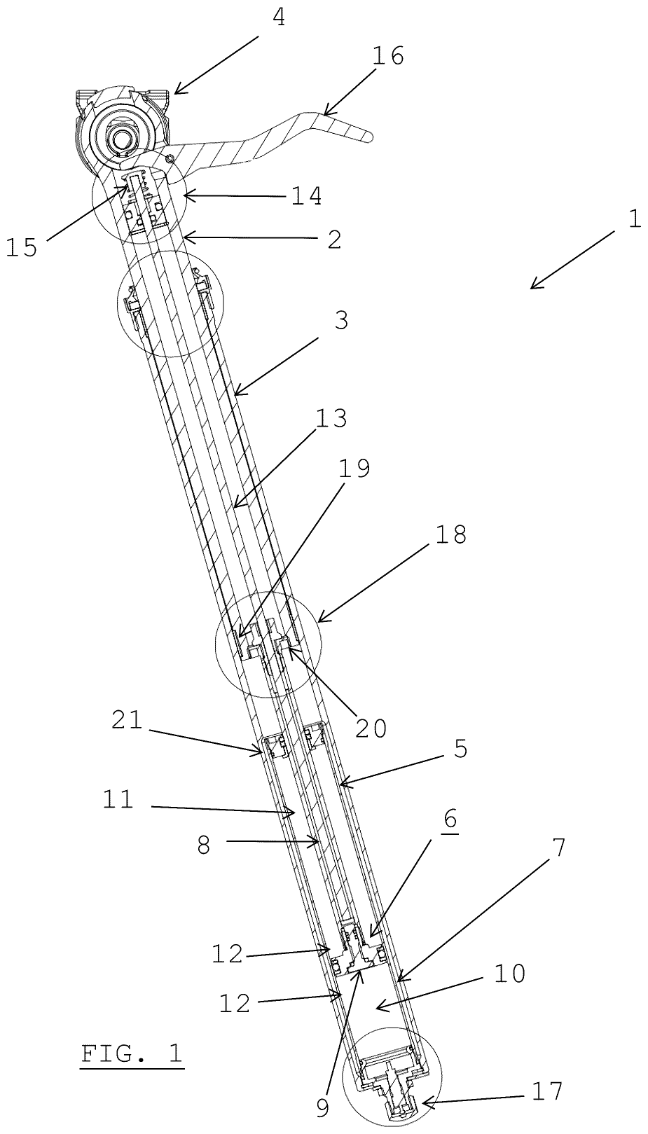

FIG. 1 shows a seatpost 1 according to one example, which firstly is divided into an upper tube 2 and a lower tube 3. A fastening device 4 for a saddle is provided on the upper region of the upper tube 2. The upper tube 2 is telescopically retractable in the lower tube 3. The upper tube 2 can however be retracted into the lower tube 3 only as far as a point at which said upper tube comes into contact with the gas spring 5. The gas spring 5, which is fastened in the lower tube 3, is held on the lower tube 3 by means of a securing ring, for example, which serves as a stop. The gas spring 5 is screwed to the seatpost by means of a washer and a nut, which is arranged coaxially with respect to the valve thread. The fastening must be able to accommodate tensile and compressive loading.

The gas spring 5 comprises a piston 6 and a cylindrical pressure housing 7. A push rod 8 attached to the piston 6 is oriented in the direction of the saddle fastening device 4. Arranged in the piston 6 itself is a first valve 9, by means of which a pneumatic connection can be produced between the positive chamber 10 and the negative chamber 11. Specifically, the pressure housing 7 comprises a chamber 12, which is divided by the piston 6 into a positive chamber 10 and a negative chamber 11, between which no exchange of gas occurs when the valve 9 is closed.

In order to actuate the valve 9, in this case a piston valve, the valve plunger is connected via the push rod 8 to a valve push rod 13, which leads to a mechanical operator control device 14. A spring 15 serves to push the actuating lever into a defined rest position, which also has the effect that no rattling occurs during riding, in particular on uneven ground.

The valve push rod is only loosely inserted and therefore cannot accommodate tensile forces. By means of a lever 16, the valve piston rod 13 can be moved counter to the spring force and open the first valve 9, such that a connection between the positive and negative chambers 10, 11 can be produced.

Provided at the opposite end is a second valve 17, by means of which air can be pumped into the positive chamber 10 from the outside. In this way, the hardness of the suspension can be adjusted, or air is replenished for other reasons. If the positive chamber 10 is filled for example via the second valve 17, the force directly after the filling of the positive chamber 10 is greater than that in the negative chamber 11. However, a one-off actuation of the first valve 1 causes a pressure equalization, restoring the normal working function of the gas spring. The suspension becomes harder with respect to shocks because it is more difficult for the piston 6, which separates the positive chamber 10 and negative chamber 11 from one another, to be moved downward; this is because there is indeed also a greater gas quantity in the chamber if air has previously been additionally introduced via the second valve 17. The spring characteristic curve of the gas spring becomes greater because the pressure in the two chambers rises as a result of the pressurization by pumping. (Force=area x pressure).

Actuation of the lever 16 causes the piston valve rod 13 to be moved away from the saddle or the saddle fastening device 4 counter to the pressure force of the spring 15. The piston valve rod 13 is mounted coaxially in the push rod 8 and can thus exert pressure on the valve plunger of the first valve 9 and thus open the first valve 9. Following actuation of the valve 1, and in the absence of a load on the saddle, the pressure in the two chambers 10, 11 is equal.

The pressure housing 7 is attached, in the lower tube 3, fixedly to the inner wall thereof. The upper tube 2 in turn is mounted on the inner wall of the lower tube 3, in the end portion 18 of the upper tube 2, by means of sliding bushings 19. The upper tube 2 is connected to the push rod 8 by means of the holding screws 20, such that, when the upper tube 2 is pushed or slid, the piston 6 is also moved accordingly. For a rotation-preventing fastening, the push rod 8 also has a thread 27 and a Hirth toothing 28 as a rotationally fixed shaft coupling. The pressure housing 7 of the gas spring 5 is sealed around the push rod 8, such that the negative chamber 11 is also closed off in the region 21. The seal is realized by means of an O-ring 22. The mounting of the closure of the pressure housing 7 with respect to the push rod 8 is implemented via a plastics bushing 23 in order to achieve higher stability between the upper tube 2 and lower tube 3. The plastics bushing 23 allows easy movement by means of sliding friction, because the friction is reduced owing the contact between two different materials such as plastics and metal.

As can be seen in FIG. 1, the diameter of the pressure housing 7 or of the gas spring 5 is at least as great as the diameter of the upper tube 2. In the present exemplary embodiment, the diameter of the pressure housing 7 or of the gas spring 5 is even almost as great as that of the lower tube 3, more specifically: The outer diameter of the pressure housing 7 or of the gas spring 5 corresponds to the inner diameter of the lower tube 3 in this region. The outer shell of the gas spring 5 or of the pressure housing 7 lies directly against the inner shell of the lower tube 3, specifically over the full circumference. The diameter of the pressure housing 7 or of the gas spring 5 is thus maximized. Since the force exerted by the piston 6 is distributed over the greatest possible area, the pressure in the gas spring 5 is minimized.

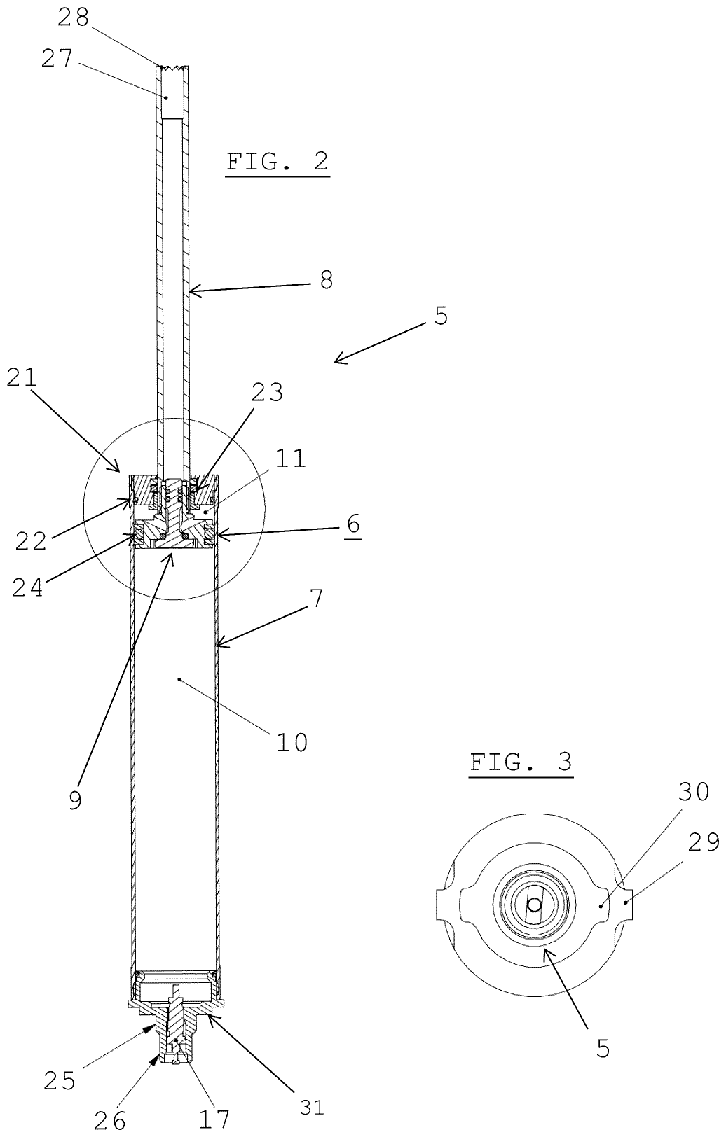

Not shown in FIG. 2 is the valve push rod 13, which extends coaxially through the push rod 8 in order to ultimately actuate the valve 9.

The piston 6 is sealed off and slidingly mounted with respect to the inner wall of the chamber or of the pressure housing 7 by a sealing arrangement 24 consisting of an O-ring surrounded by two support rings. The second valve 17 is a Schrader valve or car valve. Situated on the outer edge are the threaded retainer 25 of the gas spring 5 and the valve thread. 26, in the same way as the push rod 8 with respect to

The coaxial mounting of upper tube 2, pressure housing 7 and lower tube 3 is illustrated in cross section in FIG. 3. The pressure housing 7 of the gas spring 5 has a rotation-preventing means 29 in the form of a ring having cams. The rotation-preventing means 29 has the effect that the securing ring in turn cannot rotate, and can be installed in one position, in which the “opening” of the securing ring falls into the position 29 (groove). The cams 29, 30 correspond in terms of their position. The securing ring serves as a stop. The gas spring is screwed to the seatpost by means of a holding structure 31 composed of a washer and a nut, which is arranged coaxially with respect to the valve thread. The fastening must be able to accommodate tensile and compressive loads.

All embodiments and refinements of examples described herein have in common the fact that the pressure housing forms a cylinder which is separate from the lower tube and which is mounted coaxially in the lower tube and fixedly connected to the lower tube. This firstly allows improved maintenance because, with such a modular construction, assemblies/modules can be more easily serviced or exchanged. The gas spring does not have to be dismantled for the purposes of cleaning and lubrication of the mechanical guide (or for the exchange of guide bushings, sliding blocks etc.) of the telescopic tubes. That is to say, depressurization is also not necessary; instead, the gas spring can, together with the stanchion of the post, be pulled out upward as soon as the part 31 provided for retention (for example a sleeve nut on the lower tube head and a washer, wherein the sleeve nut receives a scraper ring for sealing the lower tube with respect to the upper tube) has been removed. It is also possible to operate with lower pressures, such that use can for example be made of conventional air pumps. Guides and rotation-preventing means can also be of more stable construction, and require less maintenance.

Although the present invention has been described with reference to preferred embodiments, workers skilled in the art will recognize that changes may be made in form and detail without departing from the spirit and scope of the invention.

### LIST OF REFERENCE SIGNS

1 Seatpost
2 Upper tube
3 Lower tube
4 Saddle fastening device
5 Gas spring
6 Piston
7 Pressure housing
8 Push rod
9 First valve
10 Positive chamber
11 Negative chamber
12 (Entire) chamber
13 Valve push rod
14 Mechanical operator control device
15 Pressure spring
16 Lever
17 Second valve
18 End region of the upper tube
19 Sliding bushing
20 Holding screws
21 End region of the gas spring
22 O-ring seal
23 Plastics bushing
24 Sealing arrangement (O-ring, support rings)
25 Threaded retainer
26 Valve thread
27 Thread
28 Hirth toothing
29 Rotation-preventing means
30 Rotation-preventing means
31 Holding structure

1. A height-adjustable seatpost with combined saddle suspension for a bicycle having a frame, comprising:
a. an upper tube having an upper end and a lower end, wherein a saddle is fastenable to the upper end,
b. a lower tube, in which the lower end of the upper tube is mounted telescopically in a plunging configuration, wherein the lower tube is couplable to the frame of the bicycle and/or can be integrated into the frame of the bicycle,
wherein
c. a gas spring is provided which couples the upper tube to the lower tube such that the upper tube can be mounted elastically in terms of a position of the upper tube relative to the lower tube, wherein the gas spring has a piston, having a push rod attached to the piston, and has a pressure housing, which forms a chamber in which the piston is mounted, wherein the push rod is connected to the upper tube and the pressure housing is connected to the lower tube,
and
the pressure housing forms a cylinder which is separate from the lower tube and which is mounted coaxially in the lower tube and fixedly connected to the lower tube.

2. The seatpost according to claim 1, wherein the piston divides the chamber into a positive chamber and a negative chamber.

3. The seatpost according to claim 2, wherein the negative chamber is arranged at a side facing the upper tube.

4. The seatpost according to claim 2, wherein the piston has a first valve for height adjustment of the gas spring and/or of the saddle, said first valve being designed to produce a pneumatic connection between the positive and the negative chamber and to conduct gas from the positive chamber into the negative chamber and/or vice versa.

5. The seatpost according to claim 4, wherein the first valve is designed as a piston valve which comprises a valve piston and a valve push rod, wherein the valve push rod is oriented from the valve piston in a direction of the upper end of the upper tube.

6. The seatpost according to claim 4, wherein the first valve is actuatable from the upper end of the upper tube.

7. The seatpost according to claim 5, wherein the valve push rod is connected to a mechanical or electrical operator control device for opening and/or closing the first valve and for height adjustment.

8. The seatpost according to claim 5, wherein the valve piston is spring-loaded in order to hold the first valve closed.

9. The seatpost according to claim 1, wherein a guide device for guiding the upper tube and as a rotation-preventing means relative to the lower tube, and/or a rotation-preventing means for the pressure housing relative to the lower tube, is/are provided, into which groove a protuberance of the upper tube and/or of the pressure housing engages.

10. The seatpost according to claim 2, wherein, at the positive chamber and/or at the pressure housing, there is arranged a second valve which is designed to produce a pneumatic connection between the positive chamber and the surroundings.

11. The seatpost according to claim 10, wherein the second valve is designed as a Schrader valve or Sclaverand valve or Blitz valve.

12. The seatpost according to claim 1, wherein the upper tube is mounted movably relative to the lower tube by means of a sliding bushing.

13. The seatpost according to claim 1, wherein the pressure housing and/or the gas spring lies directly, and/or areally over a full circumference, against an inner shell of the lower tube.

14. The seatpost according to claim 1, wherein the lower tube, on the one hand, and the pressure housing and/or the gas spring, on the other hand:
d. are of cylindrical form and/or
e. have a circular cross section.

15. The seatpost according to claim 1, wherein that end region of the gas spring which faces the upper tube forms a mechanical stop for the upper tube.

16. The seatpost according to claim 1, wherein the diameter of the gas spring and/or of the pressure housing is at least as great as the diameter of the upper tube.

17. A bicycle frame having a seatpost comprising:
an upper tube having an upper end and a lower end, wherein a saddle is fastenable to the upper end, and
a lower tube, in which the lower end of the upper tube is mounted telescopically in a plunging configuration, wherein the lower tube is couplable to the bicycle frame and/or can be integrated into the bicycle frame, wherein
a gas spring is provided which couples the upper tube to the lower tube such that the upper tube can be mounted elastically in terms of a position of the upper tube relative to the lower tube, wherein the gas spring has a piston, having a push rod attached to the piston, and has a pressure housing, which forms a chamber in which the piston is mounted,
the push rod is connected to the upper tube and the pressure housing is connected to the lower tube, and
the pressure housing forms a cylinder which is separate from the lower tube and which is mounted coaxially in the lower tube and fixedly connected to the lower tube.

18. A bicycle having a frame and a seatpost comprising
an upper tube having an upper end and a lower end, wherein a saddle is fastenable to the upper end, and
a lower tube, in which the lower end of the upper tube is mounted telescopically in a plunging configuration, wherein the lower tube is couplable to the frame of the bicycle and/or can be integrated into the frame of the bicycle, wherein
a gas spring is provided which couples the upper tube to the lower tube such that the upper tube can be mounted elastically in terms of a position of the upper tube relative to the lower tube, wherein the gas spring has a piston, having a push rod attached to the piston, and has a pressure housing, which forms a chamber in which the piston is mounted,
the push rod is connected to the upper tube and the pressure housing is connected to the lower tube, and
the pressure housing forms a cylinder which is separate from the lower tube and which is mounted coaxially in the lower tube and fixedly connected to the lower tube.

19. The seatpost according to claim 1, wherein the bicycle comprises a gravel bike.

20. The seatpost according to claim 10, wherein the pneumatic connection pumps air into the positive chamber b, or lets air out of the positive chamber, in order to adjust the hardness of the saddle suspension.
